(19) United States
(12) Patent Application Publication
(10) Pub. No.: US 2026/0179052 A1
(43) Pub. Date: Jun. 25, 2026

(54) DISPLAY CONTROL DEVICE, DISPLAY CONTROL METHOD, AND SYSTEM

(71) Applicant: CASIO COMPUTER CO., LTD., Tokyo (JP)

(72) Inventors: Kousuke ISHIZAKI, Tokyo (JP); Masaki ITO, Tokyo (JP); Yukari TAKAHASHI, Tokyo (JP); Ryosuke IWASHINA, Tokyo (JP)

(73) Assignee: CASIO COMPUTER CO., LTD., Tokyo (JP)

(21) Appl. No.: 19/427,391

(22) Filed: Dec. 19, 2025

(30) Foreign Application Priority Data
Dec. 20, 2024 (JP) 2024-225659

(51) Int. Cl. G06Q 10/1093; G06Q 10/109

(52) U.S. Cl. CPC G06Q 10/1093; G06Q 10/1097

(57) ABSTRACT

A display control device includes one or more processors. The processors: cause a display to display a plurality of candidate times of a consumer who desires a first service as a calendar format; and cause the display to display a time of providing a second service by a second supplier different from a first supplier that supplies the first service so as to correspond to the plurality of candidate times displayed in the calendar format.

### CROSS-REFERENCE TO RELATED APPLICATIONS

This application claims the priority and benefit of Japanese Patent Application No. 2024-225659 filed on December 20, 2024. The entire specification, claims, and drawings of Japanese Patent Application No. 2024-225659 are incorporated herein by reference.

### BACKGROUND

### TECHNICAL FIELD

The present disclosure relates to a display control technology.

### Related Art

An information processing apparatus capable of making communication between users smoother regarding services such as live distribution is known (for example, see JP 2021-7042 A).

### SUMMARY

A display control device includes one or more processors. The processors: cause a display to display a plurality of candidate times of a consumer who desires a first service as a calendar format; and cause the display to display a time of providing a second service by a second supplier different from a first supplier that supplies the first service so as to correspond to the plurality of candidate times displayed in the calendar format.

### BRIEF DESCRIPTION OF THE DRAWINGS

FIG. 1 is a diagram illustrating a configuration example of a distribution system;

FIG. 2 is a diagram illustrating a functional configuration example of a distribution server;

FIG. 3 is a diagram illustrating an example of a first time slot registration screen;

FIG. 4 is a diagram illustrating an example of a second time slot registration screen;

FIG. 5 is a diagram illustrating an example of a first time slot display screen;

FIG. 6 is a diagram illustrating an example of a second time slot display screen;

FIG. 7 is a diagram illustrating an example of a first transmission method;

FIG. 8 is a diagram illustrating an example of a third time slot display screen;

FIG. 9 is a diagram illustrating an example of a second transmission method;

FIG. 10 is a flowchart illustrating an example of distribution control processing; and

FIG. 11 is a diagram illustrating a hardware configuration example of an information processing apparatus.

### DETAILED DESCRIPTION

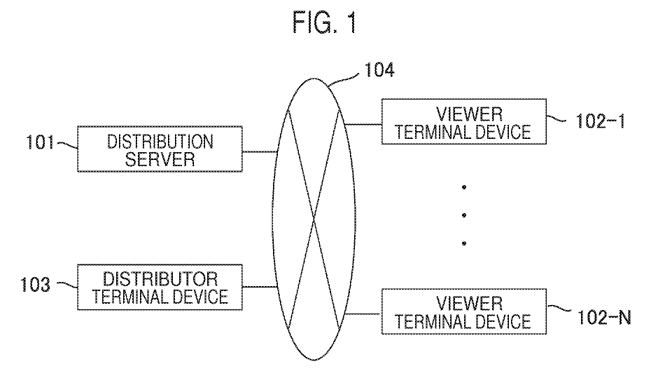

Hereinafter, embodiments will be described in detail with reference to drawings. A distribution system in FIG. 1 includes a distribution server 101, viewer terminal devices 102-1 to 102-N (N is an integer of 2 or more), and a distributor terminal device 103. The viewer terminal device 102-i (i = 1 to N) is an information processing apparatus (computer) of a viewer Ai, and the distributor terminal device 103 is an information processing apparatus of a distributor L. The viewer terminal device 102-i and the distributor terminal device 103 may be mobile terminal devices or personal computers. The mobile terminal device may be a smartphone, a tablet, or a notebook personal computer. The distribution server 101 communicates with the viewer terminal device 102-1 to the viewer terminal device 102-N and the distributor terminal device 103 via a communication network 104. The communication network 104 is, for example, a wide area network (WAN). The communication network 104 may be the Internet.

The distributor L inputs the content to be distributed to the distributor terminal device 103, and the distributor terminal device 103 transmits the input content to the distribution server 101. The content to be distributed is a video, an image, an audio, a text, a combination of these pieces of information, and the like. The content to be distributed may be live distribution content distributed in real time. The content of the live distribution may be video and audio such as talk, performance, singing, and musical instrument performance of the distributor L, or may be video and audio of game distribution. The distributor L determines a distribution time slot of the content and inputs the distribution time slot to the distributor terminal device 103, and the distributor terminal device 103 transmits the input distribution time slot to the distribution server 101. The distributor L is an example of a determiner who determines the distribution time slot of the content. The distribution server 101 distributes the content to the viewer terminal device 102-i of the viewer Ai who desires to view the content in the received distribution time slot. As a result, each viewer Ai can view the content output from the viewer terminal device 102-i. In general, in a case where the timing at which content distribution is performed does not match the timing desired by the viewer, it becomes difficult for the viewer to view the content distribution. This is not limited to live distribution using a video, and may also occur in a case where various contents are distributed to a plurality of viewers.

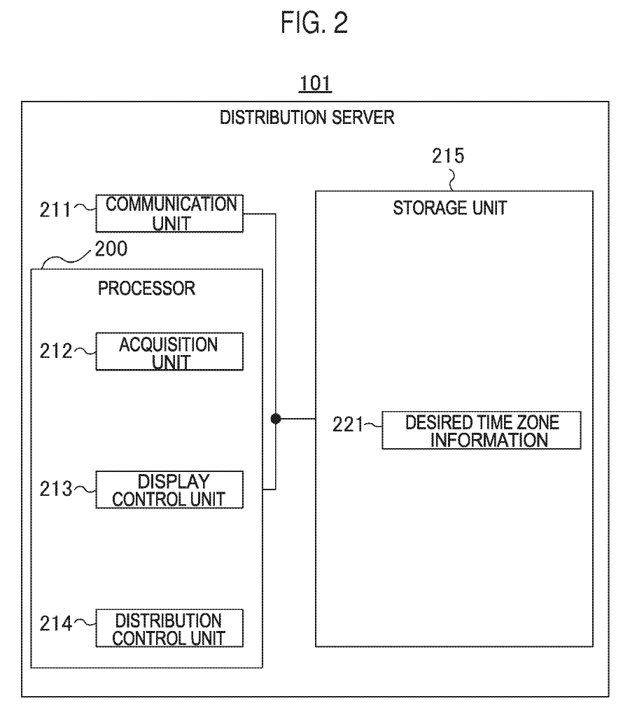

The distribution server 101 in FIG. 2 includes a processor 200, a communication unit 211, and a storage unit 215. The processor 200 includes an acquisition unit 212, a display control unit 213, and a distribution control unit 214. The processor 200 may be configured by a single central processing unit (CPU) or may be configured by a plurality of CPUs that execute processing in cooperation. The distribution server 101 is an example of a display control device. The communication unit 211 communicates with the viewer terminal device 102-1 to the viewer terminal device 102-N and the distributor terminal device 103 via the communication network 104. Each viewer terminal device 102-i displays a time slot registration screen including a plurality of candidate time slots. Each candidate time slot represents a candidate for the distribution time slot of the target content to be distributed. The viewer Ai selects one or a plurality of candidate time slots in which the viewer Ai desires to view the content among the plurality of candidate time slots included in the time slot registration screen as the desired time slot. The viewer terminal device 102-i transmits desired time slot information Bi indicating the desired time slot selected by the viewer Ai to the distribution server 101.

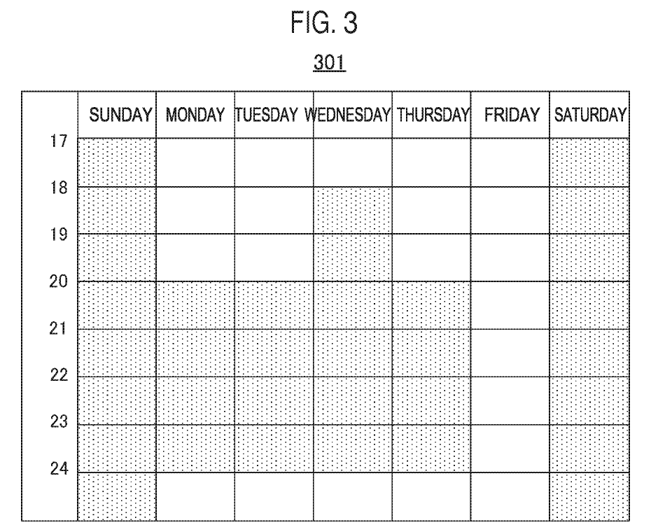

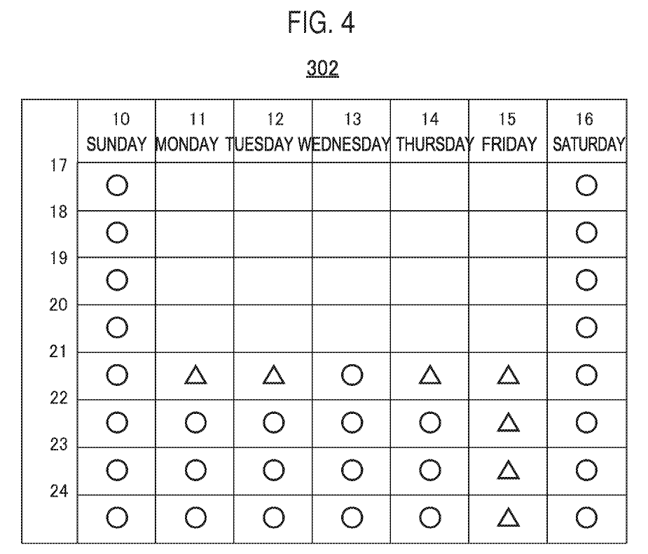

A time slot registration screen 301 in the viewer terminal device 102-i of FIG. 3 is in a calendar display format, and includes, for example, eight time slots of each day of the week from Sunday to Saturday. The eight time slots of each day are a time slot of 17:00 to 18:00, a time slot of 18:00 to 19:00, a time slot of 19:00 to 20:00, a time slot of 20:00 to 21:00, a time slot of 21:00 to 22:00, a time slot of 22:00 to 23:00, a time slot of 23:00 to 24:00, and a time slot of 24:00 to 25:00. Therefore, the time slot registration screen 301 includes 56 time slots. Among these time slots, 34 shaded time slots are selected as the desired time slots. The viewer Ai can select the 34 shaded time slots as the desired time slots by dragging the 34 shaded time slots, for example. A time slot registration screen 302 in the viewer terminal device 102-i of FIG. 4 has a calendar display format similarly to the time slot registration screen 301 of FIG. 3, and includes eight time slots of each day from Sunday to Saturday. On the time slot registration screen 302, 36 time slots to which symbols “” or “” are added are selected as the desired time slots. The time slot to which the symbol “” is added represents a first desired time slot of the viewer Ai, and the time slot to which the symbol “” is added represents a second desired time slot of the viewer Ai. Here, the time slot registration screen 301 and the time slot registration screen 302 display eight time slots of each day, but the present invention is not limited thereto, and an arbitrary time slot of 24 hours may be selectable by scroll display or the like. In addition, the time slot registration screen 301 and the time slot registration screen 302 display a calendar on a weekly basis, but can display not only on a weekly basis but also on a monthly basis or on a daily basis.

The acquisition unit 212 acquires the desired time slot information Bi by receiving the desired time slot information Bi from each viewer terminal device 102-i via the communication unit 211. Then, the acquisition unit 212 stores the desired time slot information 221 including received desired time slot information B1 to desired time slot information BN in the storage unit 215. The display control unit 213 acquires an evaluation value for each time slot by using the desired time slot information 221. For example, the display control unit 213 can acquire an evaluation value for each time slot from the number of viewers Ai who desire the time slot. In this case, the evaluation value may be the number of viewers Ai who desire the time slot, or may be a ratio of viewers Ai who desire the time slot among viewers Ai who desire to view the content of the distributor L. The evaluation value increases as the number of viewers Ai who desire viewing increases in the time slot. By acquiring the evaluation value for the time slot from the number of viewers Ai who desire each time slot, it is possible to acquire the evaluation value reflecting the number of viewers Ai who desire the time slot.

The display control unit 213 may calculate the evaluation value by weighted addition or the like using the number of viewers Ai who desire each time slot and weight Wi of the viewer Ai. In this case, the sum of the weights Wi of the viewers Ai who desire the time slot is used as the evaluation value. Therefore, the evaluation value increases as the number of viewers Ai having a large weight Wi increases in a time slot. As the weight Wi, for example, the degree of interest of the viewer Ai with respect to the distributor L can be used. The degree of interest of the viewer Ai may be the number of times or time that the viewer Ai has viewed the content distributed by the distributor L in the past. The degree of interest of the viewer Ai may be the number of times or time when the distribution schedule of the distributor L is displayed in the program guide in which the distribution schedule of the content in which the viewer Ai is interested is displayed. By calculating the evaluation value using the number of viewers Ai who desire each time slot and the weight Wi of the viewer Ai, it is possible to acquire an evaluation value reflecting different weights Wi for each viewer Ai.

The display control unit 213 generates display information of the time slot from the evaluation value of each time slot. As the display information of each time slot, for example, a color or a pattern corresponding to the evaluation value of the time slot is used. In this case, the display control unit 213 divides the distribution range of the evaluation value into a plurality of numerical ranges, and uses the color or pattern corresponding to the numerical range to which the evaluation value belongs as the display information of the time slot having the evaluation value. In a case where a color is used as the display information, the color of each time slot is changed according to the stage of the evaluation value so that the evaluation value of each time slot can be identified. For example, a darker color is used as the evaluation value is larger, and a lighter color is used as the evaluation value is smaller. The display control unit 213 outputs the display information of each time slot to the distributor terminal device 103 by transmitting the display information of each time slot to the distributor terminal device 103 via the communication unit 211. The distributor terminal device 103 receives the display information of each time slot from the distribution server 101 and displays the time slot display screen. On the time slot display screen, the time slot is displayed by using display information of each time slot. The time slot display screen is an example of a screen browsed by the determiner who determines the distribution time slot of the content. By transmitting the display information corresponding to the evaluation value of each time slot to the distributor terminal device 103, the distributor terminal device 103 can display each time slot in a different form according to the evaluation value, and can more appropriately support the determination of the distribution time slot by the distributor L. In addition, by using a color or a pattern as the display information, the distributor L can visually and easily discriminate each time slot. By changing the color of each time slot according to the stage of the evaluation value, the distributor L can identify the evaluation value of each time slot. Here, as the display information, a form of gradation display may be adopted in addition to a form such as heat map display as long as the distributor L has a display form in which it is easy to visually recognize a time slot in which the demand of the viewer Ai is high.

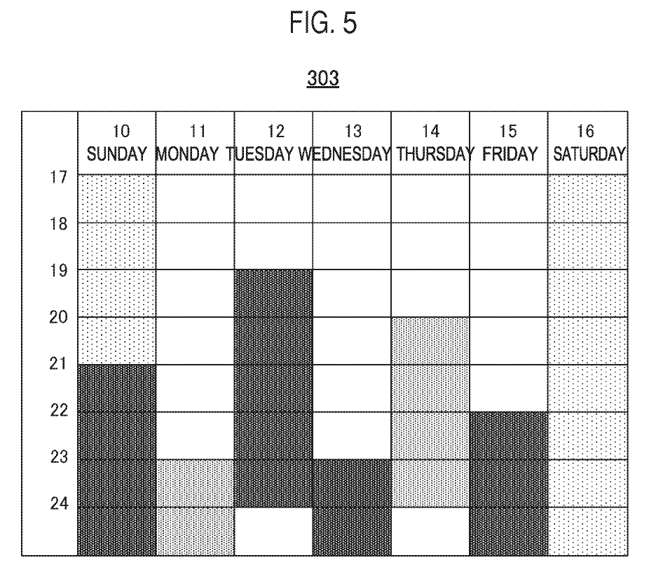

The time slot display screen 303 in the distributor terminal device 103 in FIG. 5 has a calendar display format similarly to the time slot registration screen 301 in FIG. 3 and the time slot registration screen 302 in FIG. 4, and includes, for example, eight time slots of each day of the week from Sunday to Saturday. These time slots are distinguished using three types of shading. The shading of four time slots from 21:00 to 25:00 on the 10th (Sunday), five time slots from 19:00 to 24:00 on the 12th (Tuesday), two time slots from 23:00 to 25:00 on the 13th (Wednesday), and three time slots from 22:00 to 25:00 on the 15th (Friday) represents the darkest color. The shading of two time slots from 23:00 to 25:00 on the 11th (Monday) and four time slots from 20:00 to 24:00 on the 14th (Thursday) represents the second darkest color. The shading of the four time slots from 17:00 to 21:00 on the 10th (Sunday) and the eight time slots from 17:00 to 25:00 on the 16th (Saturday) represents the lightest color. The evaluation value of the blank time slot is 0 or smaller than a predetermined value. In this way, by differentiating and displaying each time slot using the display information corresponding to the evaluation value, it is easy to find an optimal distribution time slot. For example, the distributor L selects the distribution time slot of the content from the time slots displayed in the darkest color and inputs the distribution time slot to the distributor terminal device 103, and the distributor terminal device 103 transmits the input distribution time slot to the distribution server 101. Here, the time slot display screen 303 displays 8 time slots of each day, but is not limited thereto, and an arbitrary time slot of 24 hours may be selected by scroll display or the like. In addition, the time slot display screen 303 of FIG. 5 displays the calendar on a weekly basis, but can display not only on a weekly basis but also on a monthly basis or on a daily basis.

The distribution control unit 214 receives the distribution time slot from the distributor terminal device 103 via the communication unit 211, and distributes the content to the viewer terminal device 102-i of the viewer Ai who desires to view the content in the received distribution time slot. In the case of live distribution, the distribution control unit 214 receives content transmitted from the distributor terminal device 103 in real time, and distributes the received content to the viewer terminal device 102-i. By distributing the content in any time slot displayed in the darkest color, distribution can be performed in a time slot in which the demand of the viewer Ai for the content of the distributor L is high, and the number of simultaneous connections increases.

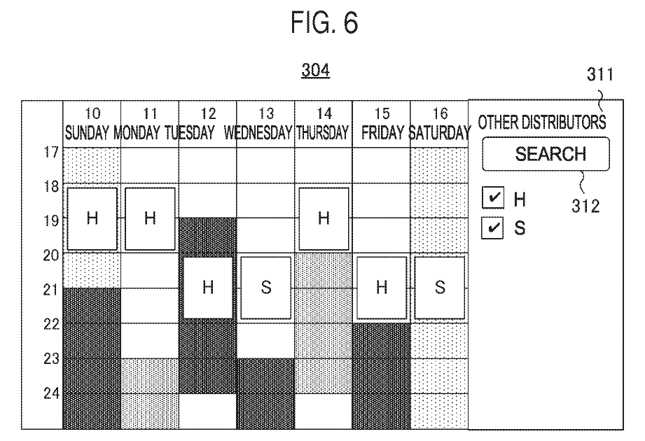

On the time slot display screen 304 in the distributor terminal device 103 of FIG. 6, the distribution time slots of the distributor H and the distributor S, which are other distributors, are displayed together on the time slot display screen 303 of FIG. 5. The distributor L searches for another distributor by using a search box 312 displayed in a screen area 311, and clicks the check boxes of the searched distributor H and distributor S, so that the distribution time slots of the distributor H and distributor S can be superimposed and displayed on the time slot display screen 303 as the time slot display screen 304. Two time slots of 18:00 to 20:00 on the 10th (Sunday), two time slots of 18:00 to 20:00 on the 11th (Monday), and two time slots of 20:00 to 22:00 on the 12th (Tuesday) are the distribution time slots of the distributor H. The two time slots of 18:00 to 20:00 on the 14th (Thursday) and the two time slots of 20:00 to 22:00 on the 15th (Friday) are also the distribution time slots of the distributor H. Two time slots of 20:00 to 22:00 on the 13th (Wednesday) and two time slots of 20:00 to 22:00 on the 16th (Saturday) are the distribution time slots of the distributor S. For example, in a case where the contents of the distributor H and the distributor S conflict with the contents of the distributor L, when the contents of the distributor L are distributed in the distribution time slot of the distributor H or the distributor S, there is a possibility that some of the viewers A1 to AN view the contents of the distributor H or the distributor S. In this case, since the number of viewers Ai who view the content of the distributor L decreases, the distributor L determines the distribution time slot of the content while avoiding the distribution time slots of the distributor H and the distributor S. By displaying distribution time slots of other distributors together, it is possible to easily determine a time slot in which the number of simultaneous connections may decrease. Note that the time slot display screen 304 is not limited to superimposing and displaying the distribution time slots of the distributor H and the distributor S on the time slot display screen 303, and the distribution time slots of the distributor H and the distributor S may be displayed beside the distribution time slot of the distributor L or the like. As the time slot display screen 304, there may be an arbitrary display format as long as it is an association in which the relevance between the distribution time slot of the distributor L and the distribution time slots of the distributor H and the distributor S is easily visible.

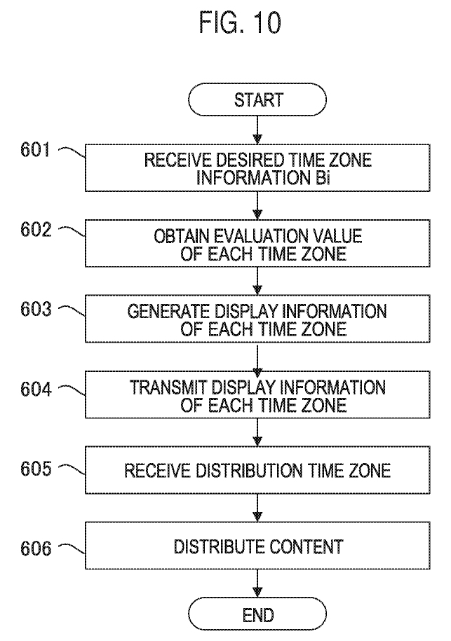

In FIG. 10, a flow of processing from the reception of the desired time slot information Bi from each viewer terminal device 102-i to the distribution of the content to the viewer terminal device 102-i will be described. First, the acquisition unit 212 receives the desired time slot information Bi from each viewer terminal device 102-i via the communication unit 211 (Step 601). Next, the display control unit 213 acquires an evaluation value of each time slot by using the desired time slot information 221 including the desired time slot information B1 to the desired time slot information BN (Step 602), and generates display information from the evaluation value of each time slot (Step 603). Then, the display control unit 213 transmits the display information of each time slot to the distributor terminal device 103 via the communication unit 211 (Step 604). Next, the distribution control unit 214 receives the distribution time slot determined by the distributor L from the distributor terminal device 103 via the communication unit 211 (Step 605), and distributes the content to the viewer terminal device 102-i in the received distribution time slot (Step 606).

The flow of processing from the reception of the desired time slot information Bi from each viewer terminal device 102-i to the distribution of the content to the viewer terminal device 102-i has been described above.

According to the present disclosure, efficient coordination of multiple services can be achieved.

This configuration reduces server-side processing load and complexity compared to conventional scheduling methods, thereby improving the technical field of scheduling systems.

Furthermore, the present disclosure enables resource optimization, providing a technical effect of enhancing user convenience and system responsiveness and improving overall operational efficiency.

Conventionally, there has been a possibility that a timing at which a service is performed by a service supplier does not necessarily match a timing desired by a service consumer.

According to the present disclosure, it is possible to more appropriately support matching between time slots of a service consumer and a service supplier.

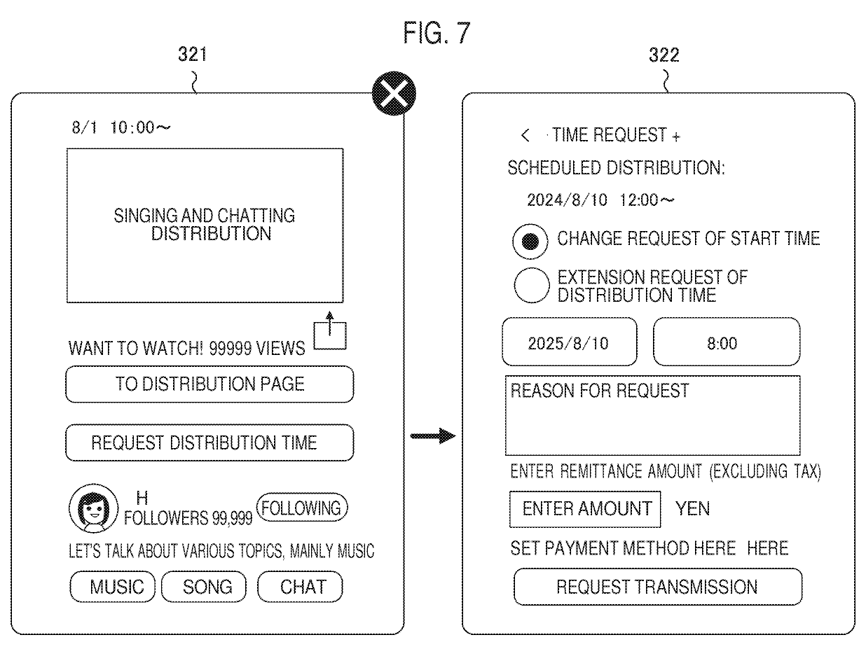

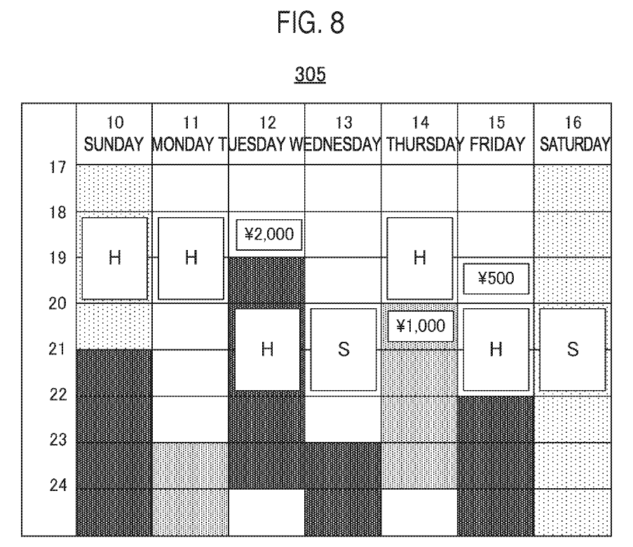

Hereinafter, the first transmission method or the second transmission method will be described for the request function from the viewer side to the distributor side. The viewer Ai who wishes to change the distribution time slot determined by the distributor L can transmit a time request for requesting the change of the distribution time slot to the distributor L by the first transmission method or the second transmission method. In the case of the first transmission method illustrated in FIG. 7, the viewer Ai displays an input screen 322 of the time request from the screen 321 of the viewer terminal device 102-i, and inputs the content of the request. As a result, a time request is generated. The time request includes, for example, the name of the viewer Ai, the distribution time slot before the change, the distribution time slot after the change, the message to the distributor L, and the remittance amount to the distributor L. The name of the viewer Ai is a real name, a display name in the distribution system, or the like. The viewer Ai pays a predetermined fee to the operator of the distribution system, and transmits the time request to the distribution server 101 using the viewer terminal device 102-i. The display control unit 213 transmits the received time request to the distributor terminal device 103, and the distributor terminal device 103 displays the time request on the screen. The distributor L confirms the distribution time slot after the change, the message to the distributor L, the remittance amount to the distributor L, and determines whether or not to change the distribution time slot included in the displayed time request. On the time slot display screen 305 in the distributor terminal device 103 of FIG. 8, the remittance amount included in the received time request is also displayed in the distribution time slot after the change included in the received time request on the time slot display screen 304 of FIG. 6. The remittance amount of 2000 yen is displayed in the time slot of 18:00 to 19:00 on the 12th (Tuesday), the remittance amount of 1000 yen is displayed in the time slot of 20:00 to 21:00 on the 14th (Thursday), and the remittance amount of 500 yen is displayed in the time slot of 19:00 to 20:00 on the 15th (Friday). By displaying the remittance amount in the distribution time slot after the change, the merit of changing the distribution time slot can be easily recognized, so that the convenience of the distributor L is improved.

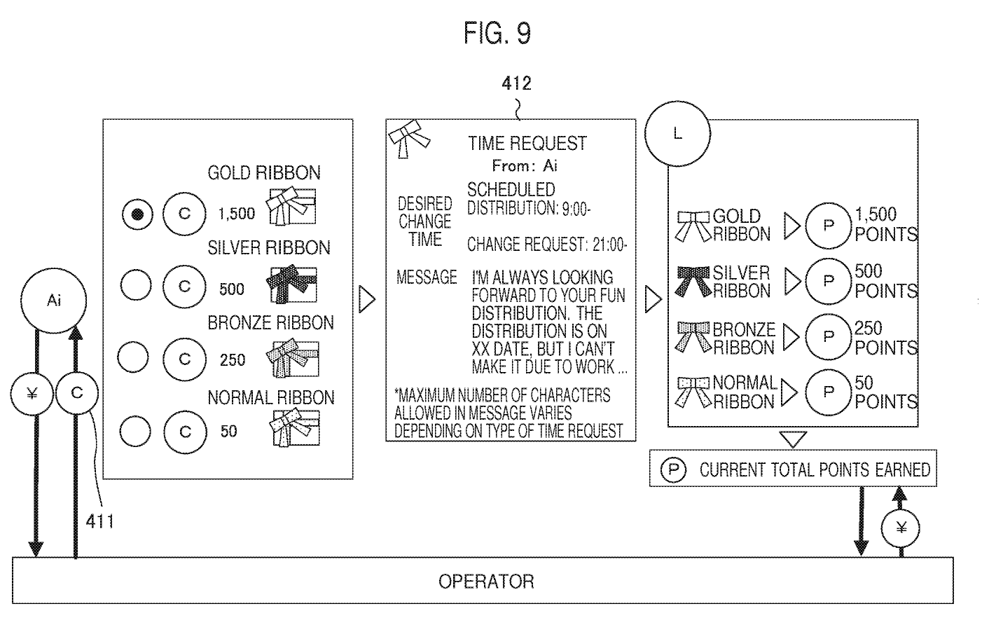

In the case of the second transmission method illustrated in FIG. 9, the time request includes, for example, the name of the viewer Ai, the distribution time slot before the change, the distribution time slot after the change, and the message to the distributor L. The viewer Ai purchases a virtual coin 411 from the operator of the distribution system, and purchases a time request 412 using the virtual coin 411. Then, the viewer Ai transmits the time request 412 to the distribution server 101 using the viewer terminal device 102-i. The display control unit 213 transmits the time request 412 received from one or the plurality of viewer terminal devices 102-i to the distributor terminal device 103. The distributor terminal device 103 displays each time request 412 and the total acquired points on a screen. The total acquired points represent the sum of the points allocated to each time request 412. The point allocated to each time request 412 is not notified to the distributor L. The distributor L can convert the total acquired points into cash by presenting the total acquired points to the operator. The operator acquires, as a commission, a difference between the amount of money corresponding to the total amount of the virtual coins 411 paid by the viewer Ai to purchase the time request 412 and the amount of money corresponding to the total acquired points presented by the distributor L. The distributor L confirms the distribution time slot after the change included in each displayed time request 412, the message to the distributor L, and the displayed total acquired points, and determines whether or not to change the distribution time slot.

Note that the viewer Ai can select any one of the time requests 412 from among the plurality of types of time requests 412 with different prices and transmit the selected time request to the distributor L. As the price of the time request 412 becomes higher, the points allocated to the time request 412 increase. In the example of FIG. 9, a gold ribbon time request 412 is selected from among four types of time requests 412 of a gold ribbon, a silver ribbon, a bronze ribbon, and a normal ribbon. The price of the gold ribbon time request 412 is 1500 coins per unit of the virtual coin 411. The price of the silver ribbon time request 412 is 500 coins, the price of the bronze ribbon time request 412 is 250 coins, and the price of the normal ribbon time request 412 is 50 coins. The viewer Ai purchases one unit of the virtual coin 411 for 2 yen from the operator. The point allocated to the gold ribbon time request 412 is 1500 points. The point allocated to the silver ribbon time request 412 is 500 points, the point allocated to the bronze ribbon time request 412 is 250 points, and the point allocated to the normal ribbon time request 412 is 50 points.

Although the present disclosure discloses content distribution, the present disclosure is not limited thereto, and can be applied to, for example, matching of time slots between a consumer of a delivery service and a supplier of the delivery service. That is, the present invention can be generally applied to time slot matching between a service consumer and a service supplier. Furthermore, the configuration of the distribution system of FIG. 1 is merely an example, and some components may be omitted or changed according to the application or condition of the distribution system. For example, the display control device may be implemented as a device different from the distribution server 101. In a case where the display control device is implemented as a device different from the distribution server 101, the display control device includes the communication unit 211, the acquisition unit 212, the display control unit 213, and the storage unit 215 in FIG. 2. The configuration of the distribution server 101 in FIG. 2 is merely an example, and some components may be omitted or changed according to the configuration or conditions of the distribution system. For example, in a case where the display control device is mounted as a device different from the distribution server 101, the communication unit 211, the acquisition unit 212, the display control unit 213, and the storage unit 215 can be omitted. The flowchart of FIG. 10 is merely an example, and some processing may be omitted or changed according to the configuration or conditions of the distribution system. The time slot registration screen illustrated in FIGS. 3 and 4 and the time slot display screen illustrated in FIGS. 5,6, and 8 are merely examples, and the time slot registration screen and the time slot display screen change according to the application or condition of the distribution system. The transmission method illustrated in FIGS. 7 and 9 is merely an example, and the viewer Ai may transmit the time request by another transmission method.

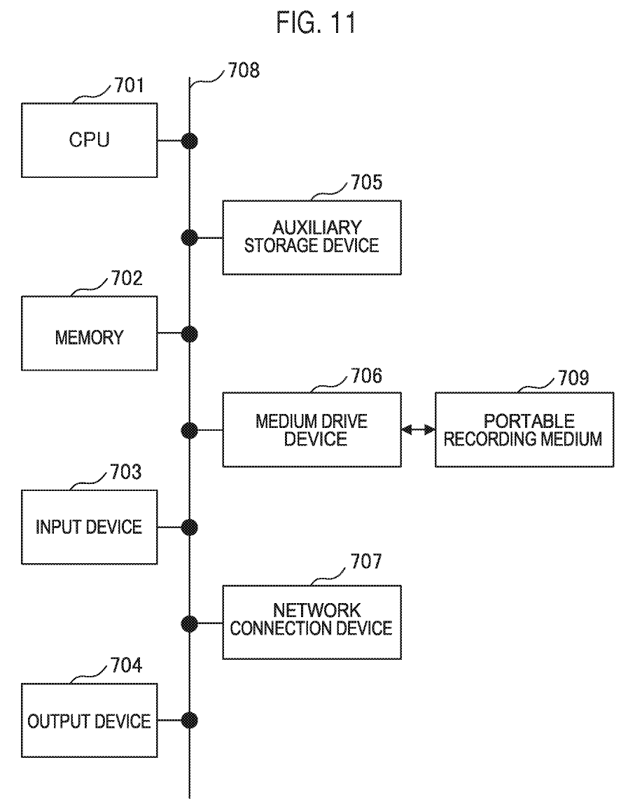

The information processing apparatus in FIG.11 is used as the distribution server 101 in FIG. 2, and includes a CPU701, a memory 702, an input device 703, an output device 704, an auxiliary storage device 705, a medium drive device 706, and a network connection device 707. These components are hardware and are connected to each other by a bus 708. The memory 702 is, for example, a semiconductor memory such as a read only memory (ROM) and a random access memory (RAM), and stores programs and data used for processing. The memory 702 may operate as the storage unit 215 in FIG. 2. The CPU701 (processor) operates as the processor 200 in FIG. 2 by executing a program using the memory 702, for example. The CPU701 also operates as the acquisition unit 212, the display control unit 213, and the distribution control unit 214 in FIG. 2, for example, by executing a program using the memory 702. The input device 703 is, for example, a keyboard, a pointing device, or the like, and is used for inputting an instruction or information from an operator or a user. The output device 704 is, for example, a display device, a printer, a speaker, or the like, and is used for an inquiry or an instruction to an operator or a user, and outputting a processing result. The processing result may be a time slot display screen. The auxiliary storage device 705 is, for example, a magnetic disk device, an optical disk device, a magneto-optical disk device, a tape device, a flash memory, or the like. The auxiliary storage device 705 may be a hard disk drive or a solid state drive (SSD). The information processing apparatus can store the program and data in the auxiliary storage device 705 and load the programs and data into the memory 702 for use. The auxiliary storage device 705 may operate as the storage unit 215 in FIG. 2. The medium drive device 706 drives a portable recording medium 709 and accesses the recorded contents. The portable recording medium 709 is a memory device, a flexible disk, an optical disk, a magneto-optical disk, or the like. The portable recording medium 709 may be a compact disk read only memory (CD-ROM), a digital versatile disk (DVD), a universal serial bus (USB) memory, or the like. The operator or the user can store the program and data in the portable recording medium 709, load the program and data into the memory 702, and use the program and data. As described above, the computer-readable recording medium that stores the program and data used for processing is a physical (non-transitory) recording medium such as the memory 702, the auxiliary storage device 705, or the portable recording medium 709. The network connection device 707 is a communication apparatus that is connected to the communication network 104 and performs data conversion accompanying communication. The information processing apparatus can receive the program and data from an external device via the network connection device 707, load the program and data into the memory 702, and use the program and data. The network connection device 707 may operate as the communication unit 211 in FIG. 2.

Note that the information processing apparatus does not need to include all the components of FIG. 11, and some components can be omitted according to the application or condition. For example, in a case where an interface with an operator or a user is unnecessary, the input device 703 and the output device 704 may be omitted. When the portable recording medium 709 is not used, the medium drive device 706 may be omitted. As the viewer terminal device 102-1 to the viewer terminal device 102-N and the distributor terminal device 103 in FIG. 1, an information processing apparatus similar to that in FIG. 11 can be used. In a case where the display control device is implemented as a device different from the distribution server 101, an information processing apparatus similar to that in FIG. 11 can be used as the display control device. Although the disclosed embodiments and their advantages have been described in detail, those skilled in the art will be able to make various changes, additions, and omissions without departing from the scope of the disclosure as clearly set forth in the claims.

What is claimed is:

1. A display control device comprising one or more processors, wherein
the processors configured to:
cause a display to display a plurality of candidate times of a consumer who desires a first service in a calendar format; and
cause the display to display a time for providing a second service by a second supplier different from a first supplier that supplies the first service so as to correspond to the plurality of candidate times displayed in the calendar format.

2. The display control device according to claim 1, wherein
the one or more processors:
designate the second supplier from a plurality of candidates different from the first supplier; and
display a time of providing the second service by the second supplier so as to correspond to the plurality of candidate times displayed in the calendar format.

3. The display control device according to claim 1, wherein
the one or more processors:
acquire desired time information indicating a time desired by each of a plurality of consumers for the first service among a plurality of times that are candidates for a providing time slot of the first service; and
acquire an evaluation value of each of the plurality of times based on the desired time information; and
cause the display to display display information corresponding to the evaluation value of each of the plurality of time slots in a calendar format.

4. The display control device according to claim 3, wherein
the one or more processors acquire the evaluation value for each of the plurality of times based on the number of consumers who desire each of the plurality of times and a weight of the consumer who desires each of the plurality of times.

5. The display control device according to claim 1, wherein
the one or more processors display the plurality of times and display information corresponding to an evaluation value of each of the plurality of times on a screen browsed by the first supplier that determines a providing time slot of the first service.

6. The display control device according to claim 1, wherein
display information corresponding to an evaluation value of each of the plurality of time slots represents a color or a pattern corresponding to the evaluation value of each of the plurality of times.

7. The display control device according to claim 6, wherein
the one or more processors output display information in which a color is changed according to a stage of the evaluation value so that the evaluation value of each of the plurality of time slots can be identified.

8. The display control device according to claim 1, wherein
the one or more processors superimpose and display a time for providing the second service on a plurality of candidate times displayed in the calendar format.

9. A display control method for causing a computer to execute:
causing a display to display a plurality of candidate times of a consumer who desires a first service as a calendar format; and
displaying a time of providing a second service by a second supplier different from a first supplier that supplies the first service so as to correspond to a plurality of candidate times displayed in the calendar format.

10. One or more processors of a system including an information processing apparatus and a display control device to cause a computer to execute:
causing a display to display a plurality of candidate times of a consumer who desires a first service as a calendar format; and
displaying a time of providing a second service by a second supplier different from a first supplier that supplies the first service so as to correspond to a plurality of candidate times displayed in the calendar format.
